(19) United States
(12) Patent Application Publication
(10) Pub. No.: US 2021/0383436 A1
(43) Pub. Date: Dec. 9, 2021

(54) ADVERTISING OPERATION SYSTEM, ADVERTISING OPERATION METHOD, AND READABLE STORAGE MEDIUM

(71) Applicant: HON HAI PRECISION INDUSTRY CO., LTD., New Taipei (TW)

(72) Inventor: WUN-CING LAI, New Taipei (TW)

(21) Appl. No.: 17/317,574

(22) Filed: May 11, 2021

(30) Foreign Application Priority Data
Jun. 3, 2020 (CN) 202010496726.4

(51) Int. Cl. G06Q 30/02; G06Q 20/36; H04L 9/30

(52) U.S. Cl. CPC G06Q 30/0273; H04L 9/30; G06Q 20/36; G06Q 30/0277

(57) ABSTRACT

An advertising operation method applied to an electronic device is provided. The method includes receiving a public key allocated by a server which acts as a seller. A request signal for obtaining a first website address of a product is sent to the server. The first website address of the product is received from the server. An encrypted electronic wallet address is obtained by encrypting a preset electronic wallet address using the public key. A second website address of the product is generated based on the first website address of the product and the encrypted electronic wallet address. The product is prompted to a client using the second website address of the product; and bonus is obtained from the server using the preset electronic wallet address.

### FIELD

The present disclosure relates to E-commerce management technology, in particular to an advertising operation system, an advertising operation method, and a readable storage medium.

### BACKGROUND

Generally, when an e-commerce platform needs to sell and promote a product, it usually contacts an advertising company, and then the advertising company contacts an advertiser to place an advertisement for prompting the product. Obviously, because the advertising company takes a part of profits provided by the e-commerce platform, the profits of the advertisers are reduced.

### BRIEF DESCRIPTION OF THE DRAWINGS

FIG. 1 illustrates a schematic diagram of an advertising operation system according to one embodiment of the present disclosure.

FIG. 2 shows one embodiment of modules of a product sale system of the present disclosure.

FIG. 3 shows one embodiment of modules of a product promotion system of the present disclosure.

FIG. 4 shows a flow chart of one embodiment of an advertising operation method of the present disclosure.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

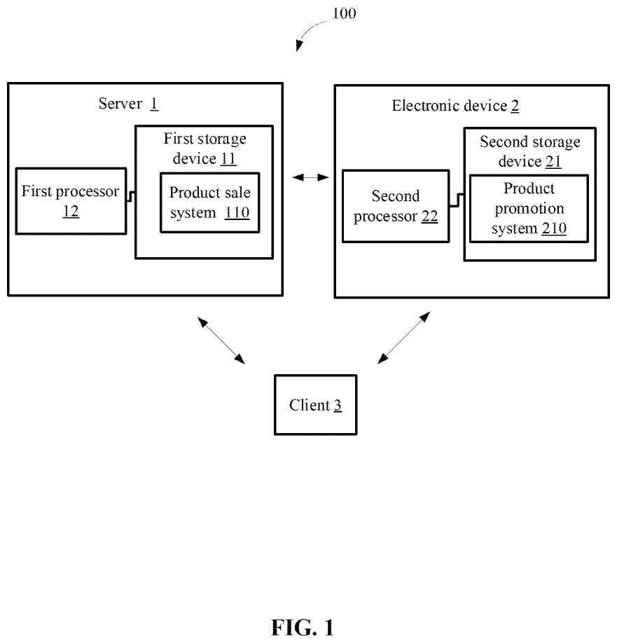

FIG. 1 illustrates a schematic diagram of an advertising operation system of the present disclosure.

In one embodiment, the advertisement operation system 100 includes a server 1 as a seller, an electronic device 2 as an advertiser, and a client 3 as a purchaser. In this embodiment, the advertiser (i.e., the electronic device 2) promotes products of the seller (i.e., the server 1) to the purchaser (i.e., the client 3). When the client 3 purchases the promoted product, the server 1 distributes bonuses to the electronic device 2. Details will be introduced in the following.

In this embodiment, the electronic device 2 and the client 3 may be personal computers, mobile phones, tablet computers and other devices. It should be noted that the electronic device 2 can also act as a purchaser at the same time.

In this embodiment, the server 1 includes a first storage device 11 and at least one first processor 12 which are electrically connected to each other. The electronic device 2 includes a second storage device 21 and at least one second processor 22 which are electrically connected to each other.

Those skilled in the art should understand that the structure of the server 1 and the electronic device 2 shown in FIG. 1 does not constitute a limitation of the embodiment of the present disclosure. The server 1 and the electronic device 2 can further include more or less other hardware or software than that shown in FIG. 1, or the server 1 and the electronic device 2 can have different component arrangements.

It should be noted that the server 1 and the electronic device 2 are merely examples. If another kind of computer device can be adapted to the present disclosure, it should also be included in the protection scope of the present disclosure, and incorporated herein by reference

In some embodiments, the first storage device 11 and the second storage device 21 may be used to store program codes and various data of computer programs. For example, the first storage device 11 may be used to store a product sale system 110 installed in the server 1 and implement completion of storing programs or data during an operation of the server 1. The second storage device 21 may be used to store a product promotion system 210 installed in the electronic device 2 and implement completion of storing programs or data during an operation of the electronic device 2.

The first storage device 11 and the second storage device 21 may respectively include Read-Only Memory (ROM), Programmable Read-Only Memory (PROM), and Erasable Programmable Read-Only Memory. EPROM), One-time Programmable Read-Only Memory (OTPROM), Electronically-Erasable Programmable Read-Only Memory (EEPROM), Compact Disc (Compact Disc) Read-Only Memory (CD-ROM) or other optical disk storage, disk storage, magnetic tape storage, or any other non-transitory computer-readable storage medium that can be used to carry or store data.

In some embodiments, each of the at least one first processor 12 and the at least one second processor 22 may be composed of an integrated circuit. For example, each of the at least one first processor 12 and the at least one second processor 22 can be composed of a single packaged integrated circuit or can be composed of multiple packaged integrated circuits with the same function or different function. Each of the at least one first processor 12 and the at least one second processor 22 includes one or more central processing units (CPUs), one or more microprocessors, one or more digital processing chips, one or more graphics processors, and various control chips. Each of the at least one first processor 12 and the at least one second processor 22 is a control unit of the server 1.

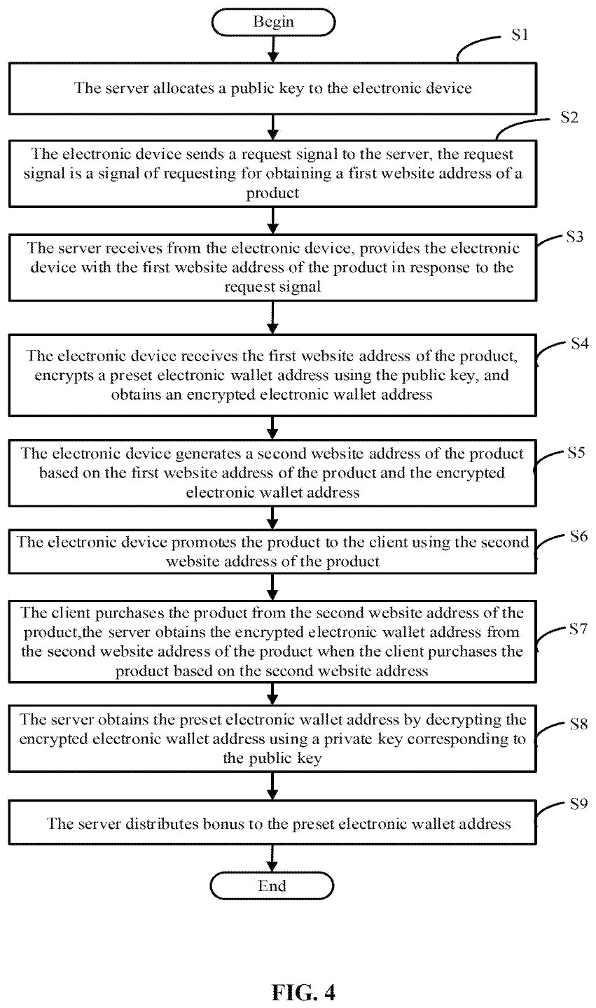

The at least one first processor 12 uses various interfaces and lines to connect various components of the server 1, and executes programs or modules or instructions stored in the first storage device 11, and invokes data stored in the first storage device 11 to perform various functions of the server 1 and to process data, for example, perform a function of selling products (for details, see the description of FIG. 4).

The at least one second processor 22 uses various interfaces and lines to connect various components of the electronic device 2, and executes programs or modules or instructions stored in the second storage device 21, and invokes data stored in the second storage device 21 to perform various functions of the electronic device 2 and to process data, for example, perform a function of prompting products (for details, see the description of FIG. 4).

In this embodiment, the product sale system 110 can include one or more modules. The one or more modules are stored in the first storage device 11 and are executed by at least one processor (e.g. first processor 12 in this embodiment), such that a function of selling products (for details, see the introduction to FIG. 4 below) is achieved.

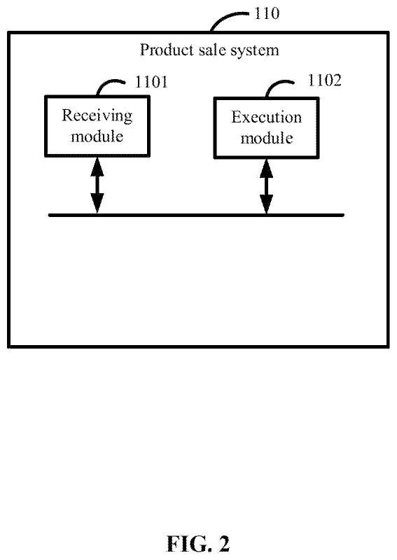

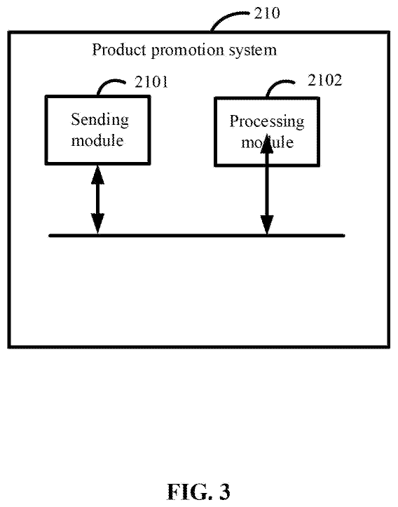

In this embodiment, the product sale system 110 can include a plurality of modules. Referring to FIG. 2, the plurality of modules includes a receiving module 1101 and an execution module 1102. The module referred to in the present disclosure refers to a series of computer-readable instructions that can be executed by at least one processor (for example, the first processor 12), and can complete functions, and can be stored in a storage device (for example, the first storage device 11 of the server 1). In this embodiment, functions of each module will be described in detail with reference to FIG. 3.

In this embodiment, an integrated unit implemented in a form of a software module can be stored in a non-transitory readable storage medium. The above modules include one or more computer-readable instructions. The server 1 or a processor implements the one or more computer-readable instructions, such that the method for selling products shown in FIG. 4 is achieved.

In a further embodiment, referring to FIG. 2, the at least one first processor 12 can execute an operating system of the server 1, various types of applications (such as the product sale system 110 described above), program codes, and the like.

In a further embodiment, the first storage device 11 stores program codes of a computer program, and the at least one first processor 12 can invoke the program codes stored in the first storage device 11 to achieve related functions. For example, each module of the product sale system 110 shown in FIG. 2 is program code stored in the first storage device 11. Each module of the product sale system 110 shown in FIG. 2 is executed by the at least one first processor 12, such that the functions of the modules are achieved, and the purpose of selling products (see the description of FIG. 4 below for details) is achieved.

In one embodiment of the present disclosure, the first storage device 11 stores one or more computer-readable instructions, and the one or more computer-readable instructions are executed by the at least one first processor 12 to achieve a purpose of selling products. Specifically, the computer-readable instructions executed by the at least one first processor 12 to achieve the purpose of selling products is described in detail in FIG. 4 below.

It should be noted that, in other embodiments, the product sale system 110 may also be implemented as an embedded system with a storage device, a processor, and other necessary hardware or software.

In this embodiment, the product promotion system 210 can include one or more modules. The one or more modules are stored in the second storage device 21 and are executed by at least one processor (e.g. second processor 22 in this embodiment), such that a function of promoting products (for details, see the introduction to FIG. 4 below) is achieved.

In this embodiment, the product promotion system 210 can include a plurality of modules. Referring to FIG. 3, the plurality of modules includes a sending module 2101 and a processing module 2102. The module referred to in the present disclosure refers to a series of computer-readable instructions that can be executed by at least one processor (for example, the second processor 22), and can complete functions, and can be stored in a storage device (for example, the second storage device 21 of the electronic device 2). In this embodiment, functions of each module will be described in detail with reference to FIG. 4.

In this embodiment, an integrated unit implemented in a form of a software module can be stored in a non-transitory readable storage medium. The above modules include one or more computer-readable instructions. The electronic device 2 or a processor implements the one or more computer-readable instructions, such that the method for promoting products shown in FIG. 4 is achieved.

In a further embodiment, referring to FIG. 2, the at least one second processor 22 can execute an operating system of the electronic device 2, various types of applications (such as the product promotion system 210 described above), program codes, and the like.

In a further embodiment, the second storage device 21 stores program codes of a computer program, and the at least one second processor 22 can invoke the program codes stored in the second storage device 21 to achieve related functions. For example, each module of the product promotion system 210 shown in FIG. 3 is program code stored in the second storage device 21. Each module of the product promotion system 210 shown in FIG. 3 is executed by the at least one second processor 22, such that the functions of the modules are achieved, and the purpose of promoting products (see the description of FIG. 4 below for details) is achieved.

In one embodiment of the present disclosure, the second storage device 21 stores one or more computer-readable instructions, and the one or more computer-readable instructions are executed by the at least one second processor 22 to achieve a purpose of promoting products. Specifically, the computer-readable instructions executed by the at least one second processor 22 to achieve the purpose of promoting products is described in detail in FIG. 4 below.

It should be noted that, in other embodiments, the product promotion system 210 may also be implemented as an embedded system with a storage device, a processor, and other necessary hardware or software.

FIG. 4 is a flowchart of an advertising operation method according to a preferred embodiment of the present disclosure.

Referring to FIG. 4, the method is provided by way of example, as there are a variety of ways to carry out the method. The method described below can be carried out using the configurations illustrated in FIG. 1, for example, and various elements of these figures are referenced in explanation of method. Each block shown in FIG. 4 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The example method can begin at block S1.

At block S1, the sending module 2101 of the electronic device 2 sends a signal of registration application to the server 1. The receiving module 1101 of the server 1 receives the signal of the registration application. When the receiving module 1101 receives the signal of the registration application, the execution module 1102 of the server 1 allocates a public key to the electronic device 2.

In this embodiment, the registration application may refer to a request to obtain a login account for logging in to a designated e-commerce platform. In an embodiment, the execution module 1102 of the server 1 stores a private key corresponding to the public key in the first storage device 11.

At block S2, the sending module 2101 of the electronic device 2 sends a request signal to the server 1, the request signal is a signal of requesting for obtaining a first website address of a product. The product is to be promoted, and the product is being sold on the designated e-commerce platform.

At block S3, the receiving module 1101 of the server 1 receives the request signal. When the receiving module 1101 receives the request signal, the execution module 1102 of the server 1 provides the electronic device 2 with the first website address of the product.

At block S4, the processing module 2102 of the electronic device 2 receives the first website address of the product, encrypts a preset electronic wallet address using the public key, and obtains an encrypted electronic wallet address.

It should be noted that the electronic wallet address may be an account in a blockchain ledger. Usually it is a combination of alphanumeric characters, or a two-dimensional code (such as Quick Response Code, QR code).

In this embodiment, the processing module 2102 of the electronic device 2 encrypts the preset electronic wallet address using the public key based on an asymmetric encryption method.

At block S5, the processing module 2102 of the electronic device 2 generates a second website address of the product based on the first website address of the product and the encrypted electronic wallet address.

In one embodiment, the processing module 2102 of the electronic device 2 generates the second website address of the product by using the first website address and the encrypted electronic wallet address based on UTM (Urchin Tracking Module) mechanism.

Specifically, the processing module 2102 of the electronic device 2 may embed the encrypted electronic wallet address as one of UTM parameters (such as a utm_content filed) into the first website address based on the UTM mechanism, thereby the second website address of the product is generated.

It should be noted that the UTM is used to track a format of a website address (URL).

For example, suppose that the first website address of the product is: https://www.example.com/sales/DXAB4A. The processing module 2102 of the electronic device 2 encrypts the preset electronic wallet address by using the public key, and obtains the encrypted electronic wallet address as: 16gsNWkmgB6mKpHQR9XrffSyf7WdpTz6kV. The processing module 2102 of the electronic device 2 may embed the encrypted electronic wallet address as the utm_content field into the first website address. For example, the second website address of the product is:
https://www.example.com/sales/DXAB4A?utm_source=eletronic_commerce&utm_m edium=blog&utm_campaign=currency_feedback&utm_term=share&utm_content=16gsNWkmgB6mKpHQR9XrffSyf7WdpTz6kV.

At block S6, the processing module 2102 of the electronic device 2 provides the client 3 with the second website address of the product. That is, the processing module 2102 of the electronic device 2 promotes the product to the client 3 using the second website address of the product.

At block S7, the client 3 purchases the product from the second website address of the product. The execution module 1101 of the server 1 obtains the encrypted electronic wallet address from the second website address of the product when the client 3 purchases the product based on the second website address.

Specifically, the execution module 1101 of the server 1 obtains the encrypted electronic wallet address by obtaining the content of the utm_content field from the second website address of the product.

At block S8, the execution module 1101 of the server 1 obtains the preset electronic wallet address by decrypting the encrypted electronic wallet address using the private key corresponding to the public key.

At block S9, the execution module 1101 of the server 1 distributes bonus to the preset electronic wallet address. Therefore, the electronic device 2 obtains the bonus distributed by the server 1 by using the electronic wallet address.

Specifically, the execution module 1101 of the server 1 may deposit a preset amount of virtual currency into the preset electronic wallet address according to a preset profit distribution rule (for example, using a preset percentage of a sales price of the product as a bonus).

It can be seen from the above blocks of the present disclosure that the electronic wallet address of the advertiser is encrypted with the public key provided by the seller, and then the encrypted electronic wallet address is embed into the URL of the product using the UTM mechanism. When the client purchases the product through the URL that is embedded with the encrypted electronic wallet address, the server as the seller distributes the profit of promoting the product to the electronic wallet address of the advertiser. Therefore, the process of product promotion is shorted and an efficiency of product promotion is improved, and realizing that the advertiser directly obtains the profit of product promotion from the seller.

In addition, in the second URL of the product generated using the UTM mechanism, the content of the utm_content field is the electronic wallet address encrypted with the public key provided by the seller. That is, the public key is bound to the e-wallet address of the product and the advertiser, which can prevent an illegal person (not the advertiser) from changing the encrypted electronic wallet address to be an electronic wallet address of the illegal person, and prevent the seller from remitting the promotion profit to the electronic wallet address of the illegal person when the product is sold to the seller.

The above description is only embodiments of the present disclosure, and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. An advertising operation system comprising a server, an electronic device, and a client, wherein:
the server allocates a public key to the electronic device;
the server receives from the electronic device, a request signal for obtaining a first website address of a product;
the server provides the electronic device with the first website address of the product in response to the request signal;
the electronic device receives the first website address of the product, encrypts a preset electronic wallet address using the public key, and obtains an encrypted electronic wallet address;
the electronic device generates a second website address of the product based on the first website address of the product and the encrypted electronic wallet address;
the electronic device promotes the product to the client using the second website address of the product;
the server obtains the encrypted electronic wallet address from the second website address of the product when the client purchases the product based on the second website address;
the server obtains the preset electronic wallet address by decrypting the encrypted electronic wallet address using a private key corresponding to the public key; and
the server distributes bonus to the preset electronic wallet address.

2. The advertising operation system according to claim 1, wherein the electronic device generates the second website address of the product by using the first website address and the encrypted electronic wallet address based on urchin tracking module mechanism.

3. An advertising operation method appliable to a server, comprising:
allocating a public key to an electronic device;
receiving from the electronic device, a request signal for obtaining a first website address of a product;
providing the electronic device with the first website address of the product in response to the request signal;
obtaining an encrypted electronic wallet address from a second website address of the product when a client purchases the product based on the second website address, wherein the second website address of the product is generated based on the first website address of the product and an encrypted electronic wallet address, the encrypted electronic wallet address is obtained by encrypting a preset electronic wallet address using the public key;
obtaining the preset electronic wallet address by decrypting the encrypted electronic wallet address using a private key corresponding to the public key; and
distributing bonus to the preset electronic wallet address.

4. An advertising operation method appliable to an electronic device, comprising:
receiving a public key allocated by a server;
sending a request signal for obtaining a first website address of a product to the server;
receiving the first website address of the product from the server;
encrypting a preset electronic wallet address using the public key, and obtaining an encrypted electronic wallet address;
generating a second website address of the product based on the first website address of the product and the encrypted electronic wallet address;
promoting the product to a client using the second website address of the product; and
obtaining bonus from the server using the preset electronic wallet address.

5. The advertising operation method according to claim 4, further comprising:
generating the second website address of the product by using the first website address and the encrypted electronic wallet address based on urchin tracking module mechanism.
